(19) United States
(12) Patent Application Publication
(10) Pub. No.: US 2022/0191162 A1
(43) Pub. Date: Jun. 16, 2022

(54) NETWORK NODES AND METHODS PERFORMED THEREIN FOR HANDLING MESSAGES

(71) Applicant: Telefonaktiebolaget LM Ericsson (publ), Stockholm (SE)

(72) Inventors: Charles HEGARTY, Stockholm (SE); Ester GONZALEZ DE LANGARICA, Grapevine, TX (US)

(73) Assignee: Telefonaktiebolaget LM Ericsson (publ), Stockholm (SE)

(21) Appl. No.: 17/595,387

(22) PCT Filed: May 28, 2019
(86) PCT No.: PCT/SE2019/050492

§ 371 Date: Nov. 15, 2021

(51) Int. Cl. H04L 51/224; H04L 51/18

(52) U.S. Cl. CPC H04L 51/24; H04L 51/18

(57) ABSTRACT

A method performed by a first network node in a wireless communications network, for handling messages of a user. The first network node receives, from a second network node, one or more messages or notifications of messages associated to the user, and a respective privacy indication for each message. The first network node further handles, based on the respective privacy indication, each message or notification of message.

### TECHNICAL FIELD

Embodiments herein relate to network nodes and methods performed therein for handling messages of a user in a communication network.

### BACKGROUND

Over-The-Top (OTT) services have been introduced in wireless communication networks allowing a third party telecommunications service provider to provide services that are delivered across an IP network. The IP network may e.g. be a public internet or cloud services delivered via a third party access network, as opposed to a carrier's own access network. OTT may refer to a variety of services including communications, such as e.g. voice and/or messaging, content, such as e.g. TV and/or music, and cloud-based offerings, such as e.g. computing and storage.

Traditional communication networks such as e.g. IP Multimedia Subsystem (IMS) Networks are based on explicit session initiation protocol (SIP) signalling methods. The IMS network typically requires a user to invoke various communication services by using a keypad and/or screen of a smart device. A further OTT service is a Digital Assistant (DA). The DA may perform tasks or services upon request from a user. The DA may be implemented in several ways. A first way is commonly referred to as an operator controlled DA. The operator controls the whole DA solution without the UE being impacted. A user of the UE may provide instructions, such as e.g. voice commands, to a core network node, such as e.g. an IMS node, of the operator. The voice command may e.g. be “Digital Assistant, I want a pizza”, “Digital Assistant, tell me how many devices are active right now”, “Digital Assistant, set-up a conference”, or “Digital Assistant, how much credit do I have?”. The take up of Digital Assistants has grown rapidly the last couple of years. With the entrance of Smart Speakers, the Voice Bots or Digital Assistants have become easier to access than software (SW) clients on Smartphones and other hardware (HW).

Network Operators have identified the area of Digital Assistants as a possible source of new revenues. Carriers and/or mobile network operators (MNO) are engaging with the big DA providers to enable telephony and messaging to these devices. The core network node may detect a hot word, which may also be referred to as a key word, indicating that the user is providing instructions to the DA and may forward the instructions to a network node controlled by a third party service provider, the network node may e.g. comprise a DA platform. The DA platform may e.g. be a bot of a company providing a certain service, such as e.g. a taxi service or a food delivery service. The instructions may be forwarded to the DA platform using e.g. a Session Initiation Protocol/Real-time Transport Protocol (SIP/RTP). The DA platform may comprise certain functionality, such as e.g. Speech2Text, Identification of Intents & Entities and Control & Dispatch of Intents. The DA platform may then forward the instructions to a further network node, which may e.g. be an Application Server (AS) node, which has access to the core network node via a Service Exposure Application Programming Interface (API). Thereby the DA may access the IMS node and perform services towards the core network node. The DA platform is often required to pay a fee to the operator in order to be reachable by the operator's DA users. The user may also be required to pay fees to the operator and network provider for the usage of DA services. The operator may further be required to pay fees to the network provider for every transaction performed via the Service Exposure API.

A further way to implement the DA may be to provide the user with direct access to the network node controlled by the third party service provider comprising the DA platform. This may e.g. be done using a dedicated UE having access to the first network node. This way of implementing the DA is commonly referred to as an OTT-controlled DA. One of the services that can be invoked may e.g. be a telephony services or bot, implemented by the operator. FIG. 1 shows one of the current architectures being discussed known as the OTT-controlled digital assistant. While the user is in a call, the user may request to involve the IMS network. If the request from the smart speaker user needs some IMS capabilities the OTT DA cloud will use service exposure capabilities to access to it. For example, when the user asks to include a 3^{rd} person to the call or manipulate end user supplementary setting.

One obvious IMS capability the user would like to access via DA is messaging.

It is assumed that voice authentication is available. The DA is capable of identifying which person is making the request. The messaging handling feature is expected to work in shared devices. For example, a family device/smart speaker where everyone can make requests and the device will serve the request to each user.

OTTs have indicated that they are not interested in storing the messages (and thus “acting” as an MNO) due to regulation issues, but on acting as a proxy between the user and the IMS network.

Messages can be both voice or text messages.

The scenario would be something similar to:

User: “Digital Assistant, what's new?

DA: You have 5 text messages

User: Read all my messages

DA:
1^{st} message: you have an important message from Maria sent today at 9 h45.
   Remember our appointment today for lunch
2^{nd} message: you have a message from Robert. Sent today at 10 h30.
   I call you to wish you Happy Xmas
Etc.

Herein it is a focus on messaging capability when exposed via DA cloud.

Privacy and security issues arise when the output device e.g. a smart speaker is shared. When requesting fetching and reading of messages all information will be read out regardless of its sensitivity. Everyone in the vicinity of the shared output device will hear the messages.

From a user perspective it may be acceptable that some of the messages are played publicly but not all. Certain privacy criteria exist that may be based on for example; the message sender, the persona of the message sender, for example, the user may be ok with playing the messages from Robert when calling as a friend but not ok with playing messages from Robert when messaging as my manager. The user may never want messages that are sent for example from “doctor”.

The newly introduced GSMA concept of multi-persona further complicates the privacy criteria e.g. see example above “Robert as friend, Robert as manager”.

### SUMMARY

An object of embodiments herein is to provide a messaging service to a user in a secure and reliable manner.

The object may be achieved by providing a method performed by a first network node, e.g. a digital assistant node, in a wireless communications network, for handling one or more messages of a user. The first network node receives, from a second network node such as an application server, one or more messages or notifications of messages associated to the user, and a respective privacy indication for each message. The first network node further handles, based on the respective privacy indication, each message or notification of message, e.g. outputs the message or not.

The object may further be achieved by providing a method performed by a second network node, such as an IMS node, in a wireless communications network for handling one or more messages of a user. The second network node transmits to a first network node, one or more messages or notifications of messages associated with the user and a respective privacy indication for each message or notification of message.

It is furthermore provided herein a computer program product comprising instructions, which, when executed on at least one processor, cause the at least one processor to carry out any of the methods above, as performed by the first or the second network node respectively. It is additionally provided herein a computer-readable storage medium, having stored thereon a computer program product comprising instructions which, when executed on at least one processor, cause the at least one processor to carry out the method according to any of the methods above, as performed by the first or the second network node respectively.

The object may be achieved by providing a first network node, e.g. a digital assistant node, in a wireless communications network, for handling one or more messages of a user. The first network node is configured to receive, from a second network node such as an application server, one or more messages or notifications of messages associated to the user, and a respective privacy indication for each message. The first network node is further configured to handle, based on the respective privacy indication, each message or notification of message, e.g. outputs the message or not.

The object may further be achieved by providing a second network node, such as an IMS node, in a wireless communications network for handling one or more messages of a user. The second network node is configured to transmit to a first network node, one or more messages or notifications of messages associated with the user and a respective privacy indication for each message or notification of message.

The herein proposed solution provides a secure manner to provide messages to a user of one or more output devices such as a smart speaker and a smart phone. Some messages of a privacy level, such as a low privacy e.g. public messages, may be output by a public output device such as the smart speaker and some messages of high privacy may be handled differently such as a text notification or an audio notification and/or output by a secure output device such as a smart phone. The messages may be retrieved and based on the privacy indication triggered to be output on one of the output devices. Thus, embodiments herein provide secure ways of handling messages for a user.

### BRIEF DESCRIPTION OF THE DRAWINGS

The embodiments herein will now be described and explained in more detail in relation to the enclosed drawings, in which:

FIG. 1 is a schematic overview depicting a communications network comprising a third party service in a Voice Instruction Based Platform;

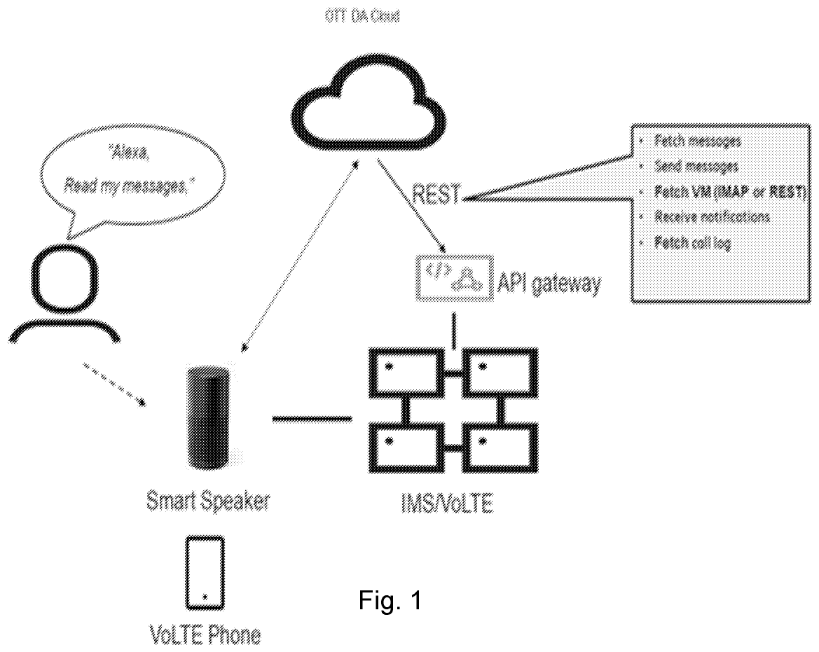

FIG. 2 is a schematic overview depicting a communications network comprising a third party service in a Voice Instruction Based Platform;

FIG. 3 is a combined flowchart and signalling scheme according to some embodiments herein;

FIG. 4 is a combined flowchart and signalling scheme according to some embodiments herein;

FIG. 5 is a combined flowchart and signalling scheme according to some embodiments herein;

FIG. 6 is a combined flowchart and signalling scheme according to some embodiments herein;

FIG. 7 is a combined flowchart and signalling scheme according to some embodiments herein;

FIG. 8 is a schematic flowchart depicting a method performed by a first network node according to embodiments herein;

FIG. 9 is a schematic flowchart depicting a method performed by a second network node according to embodiments herein;

FIG. 10 is a block diagram depicting a first network node according to embodiments herein; and

FIG. 11 is a block diagram depicting a second network node according to embodiments herein.

### DETAILED DESCRIPTION

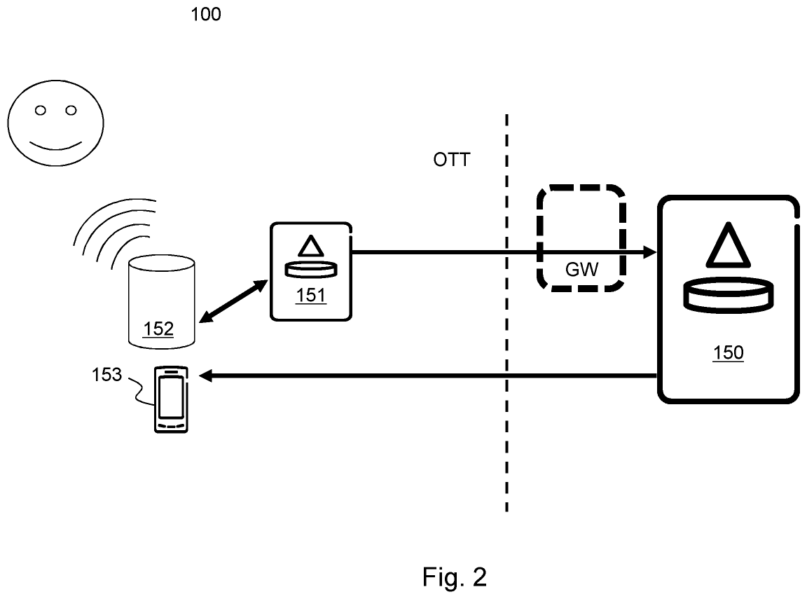

Embodiments herein relate to communication networks in general. FIG. 2 is a schematic overview depicting a wireless communication network 100. The wireless communication network 100 comprises one or more mobile access networks such as radio access networks (RAN) and one or more core networks (CN). The wireless communication network 100 may use one or a number of different technologies. Embodiments are applicable in 5G networks and also in further development of existing communication systems such as e.g. LTE and Wideband Code Division Multiple Access (WCDMA).

In the wireless communication network 100, users communicate with the CN or application servers (AS) using one or more output devices such as a user equipment (UE) e.g. a smart speaker, a mobile station, a non-access point station (non-AP STA), a STA, a wireless device and/or a wireless terminal. It should be understood by the skilled in the art that “UE” is a non-limiting term which means any terminal, wireless communication terminal, wireless device, narrowband-internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node or a wireless device. Thus, a user may use a first output device 152 such as a smart speaker and a second output device 153 such as a mobile phone.

The wireless communication network 100 further comprises a first network node 151 such as a digital assistant (DA) node being part of a digital assistant set-up such as a digital assistant cloud, wherein services are provided based on instructions from e.g. the first output device 152. The first network node 151 may thus be a part of an OTT DA cloud architecture.

The first network node 151 is communicating with a core network node referred to as a second network node 150 such as an IMS node being part of IMS architecture such as an application server (AS) providing e.g. a messaging service to users. The second network node 150 may be located behind a gateway node (GW) or similar.

The wireless communication network 100 may further comprise a radio network node, also referred to as a first radio network node, providing radio coverage for one or more output devices over a geographical area of a first radio access technology (RAT), such as NR, LTE or similar. The radio network node may be a transmission and reception point allowing the output device connection to access network such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used.

According to embodiments herein the user may request received messages from the first output device 152 e.g. by requesting message using a voice request, e.g. “Do I have any messages?”. The first output device 152 may receive the voice request and interpret the voice request as a trigger to retrieve messages of the user. The first output device 152 may then send the request to the first network node 151 in e.g. the DA cloud. The first network node 151 may then retrieve one or more messages for the user from the second network node 150 along with a respective privacy indication of each message or notification of message. The first network node 151 may further send e.g. messages of a first level of privacy e.g. public messages, to the first output device 152 to be play back for the user, whereas messages of e.g. a second privacy level, e.g. private messages, are not played back over the first output device 152. The embodiments herein may enable a privacy and security policy framework to be implemented in the OTT cloud. IMS may provide key attributes such as the privacy indications that are used to enable the security policies towards the user or smart speaker. Based on messages fetched by the OTT cloud from the IMS network, IMS may indicate to the OTT DA cloud the needed parameters so the OTT can then enforce the privacy settings according to user preferences as configured in a privacy policy.

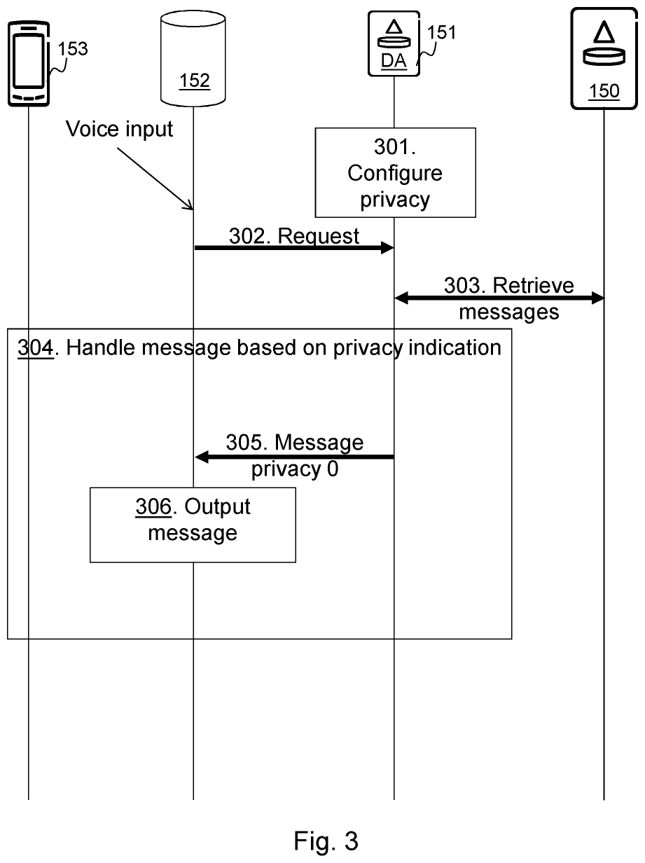

FIG. 3 is a combined signalling scheme and flowchart according to embodiments herein for handling messages of the user.

Action 301. Privacy setting may be configured at the first network node. E.g. a privacy policy of the user in the IMS may be mirrored to the first network node 151 or may be configurable via a web portal or similar. Thereby may conditions and rules for handling messages of different privacy level be set.

Action 302. The first output device 152 receives a voice input such as a voice command indicating retrieval of messages of a user, and transmits a request to the first network node 151 for the messages of the user. The request may comprise service ID, user ID, and more.

Action 303. The first network node 151 then retrieves messages of the user from the second network node 150. E.g. the messages are identified for the user based on the user ID or similar. A respective privacy indication for each message is also retrieved e.g. information of privacy, this information may be: sender id, a block-chain-based identity and/or a privacy indication.

Action 304. The first network node 151 may then handle the messages based on the respective privacy indication of each message. E.g. play back on the first output device 152 in case of public message and if private message trigger a notification to the user for the user to e.g. read the messages from the second output device 153. The privacy indication can be a Boolean value e.g. Yes it's private, No, it's not private, or a more sophisticated value, or a rule indicating, for example:
Public: The message can be played in front of any audience
Private_on_this_speaker: The message must be omitted when the request comes from this particular device
Private_but_opaque. The audio will say this message exists, but it will not reveal the content. For example. You have 3 regular messages and 2 private messages.

Action 305. E.g. a first message of a privacy level of zero is sent from the first network node 151 to the first output device 152.

Action 306. The first output device 152 may then play back the message for the user or environment based on the privacy level indicated.

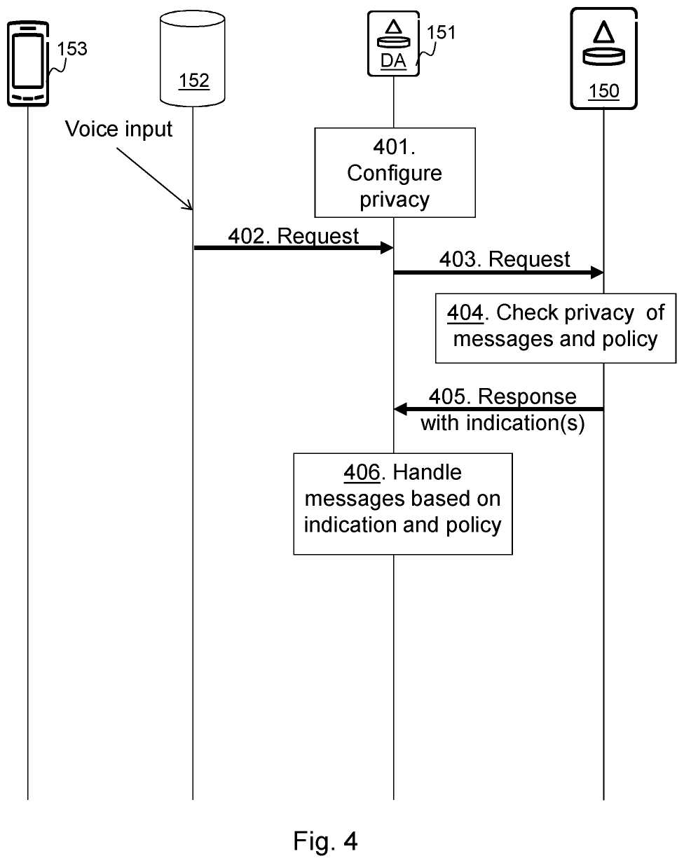

FIG. 4 is a combined signalling scheme and flowchart according to embodiments herein for handling messages of the user.

Action 401. Privacy setting may be configured at the first network node 151. E.g. a privacy policy of the user in the IMS may be mirrored to the first network node 151 or may be configurable via a web portal or similar. Thereby may conditions and rules for handling messages of different privacy level be set.

Action 402. The first output device 152 receives a voice command indicating retrieval of messages of a user, and transmits a request to the first network node 151 for the messages of the user. The request may comprise service ID, user ID, and more.

Action 403. The first network node 151 then sends to the second network node 150 a request of messages of the user.

Action 404. The second network node 150 may then check privacy of messages and setup privacy policy subscribed by the user. E.g. which messages have the user configured as private messages, which contacts, type of numbers etc. are marked as private in the policy.

Action 405. The second network node 150 may then transmit a response to the first network node indicating messages and respective privacy indication.

Action 406. The first network node 151 may then handle the messages based on the respective privacy indication of each message and may further take configured privacy policy into account. E.g. play back in case of public message on the first output device 152 and just trigger a text message to the second output device 153 in case of private message.

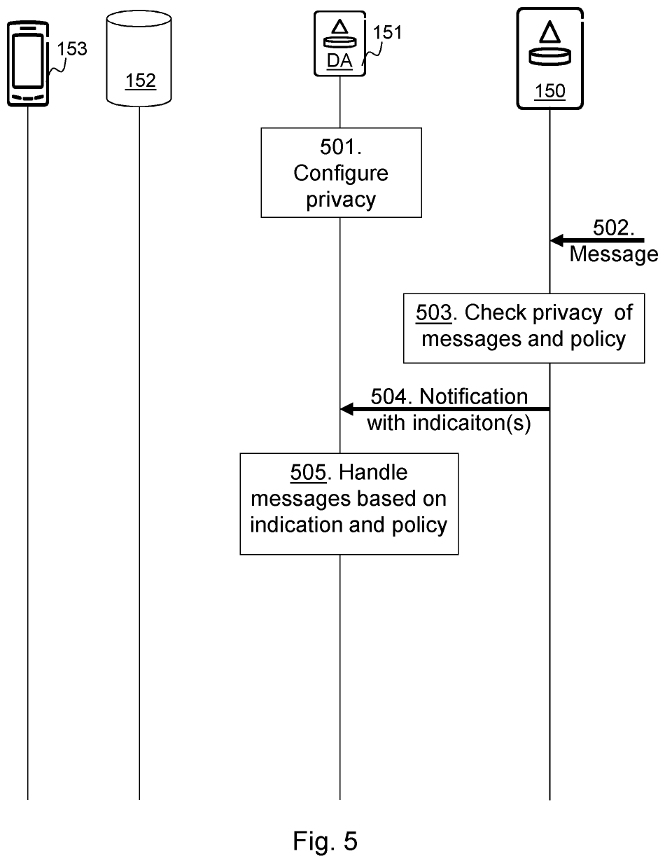

FIG. 5 is a combined signalling scheme and flowchart according to embodiments herein for handling messages of the user.

Action 501. Privacy setting may be configured at the first network node 151. E.g. a privacy policy of the user in the IMS may be mirrored to the first network node 151 or may be configurable via a web portal or similar. Thereby may conditions and rules for handling messages of different privacy level be set.

Action 502. The second network node 150 may receive one or more messages for a user from one or more originating parties.

Action 503. The second network node 150 may then check privacy of messages and setup privacy policy subscribed by the user. E.g. check originating ID with a list stored in the second network node indicating which numbers, persons, or type of calls that are private and which are public.

Action 504. The second network node 150 may then transmit one or more notifications of messages e.g. an indication of a message. Each notification of message is transmitted with a privacy indication. This may also be triggered by a request from the user.

Action 505. The first network node 151 may then handle the notifications of messages based on the respective privacy indication of each message and may further take configured privacy policy into account. E.g. retrieve message and play back on the first output device 152 in case of notification indicates a public message and e.g. notify the user by using the second output device 153 in case the notification indicates a private message.

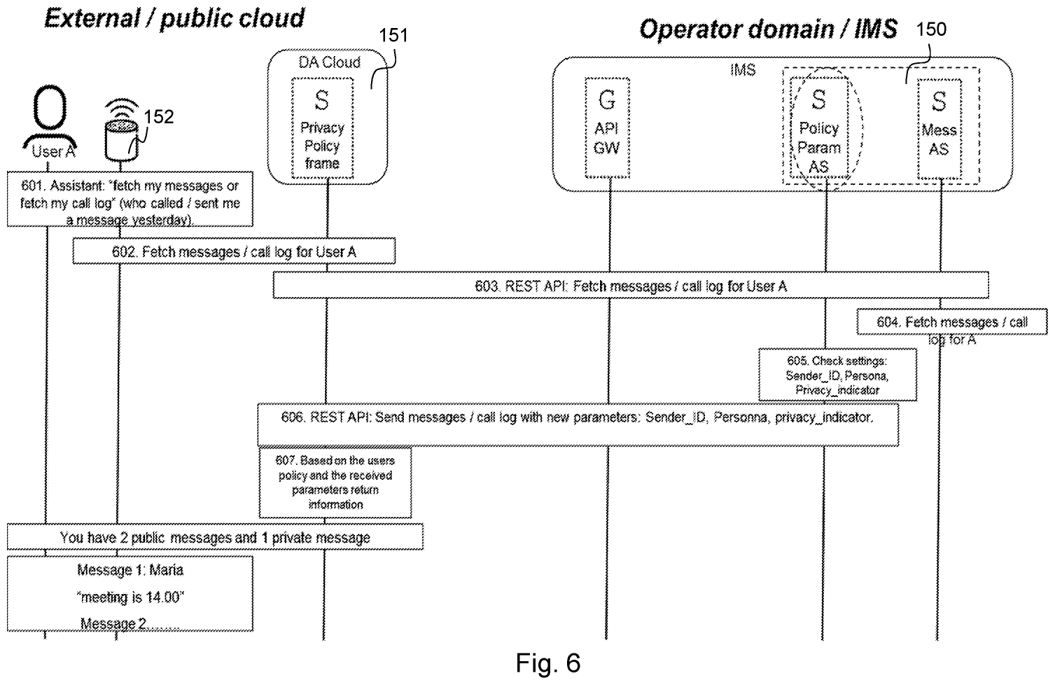

FIG. 6 is a combined signalling scheme and flowchart according to embodiments herein for handling messages of a user A.

Action 601. The user A may request the first output device “Assistant: fetch my messages or fetch my call log”. I.e. the user A requests information regarding who called and/or sent me a message yesterday.

Action 602. The first output device 152 may then indicate a request to fetch messages and/or call log for user A to the first network node 151.

Action 603. The first network node 151 e.g. with a configured privacy policy frame for the user A may then indicate retrieval of messages of the user A on an application programming interface such as a REST API. I.e. transmit to the second network node 150, a request to fetch messages and/or call log for user A.

Action 604. The messages and/or call log may be fetched from a messaging server such as a AS.

Action 605. The second network node 150 may then check privacy of messages and setup privacy policy subscribed by the user A. E.g. check settings such as sender ID, persona, privacy indication or indicator, and/or similar. Persona is used to determine role of the sender ID, e.g. Chris-from work or Chris-from school etc.

Action 606. The second network node 150 may then transmit one or more messages and/or call log of the user A to the first network node 151. Each message is transmitted with a privacy indication. Respective sender ID and/or persona may also be transmitted.

Action 607. The first network node 151 may then handle the messages based on the respective privacy indication of each message and may further take configured privacy policy into account. E.g. based on the users policy and the received parameters such as privacy indication, return information.

E.g. output to the user through the first output device 152 that the user A have 2 public message and 1 private message.

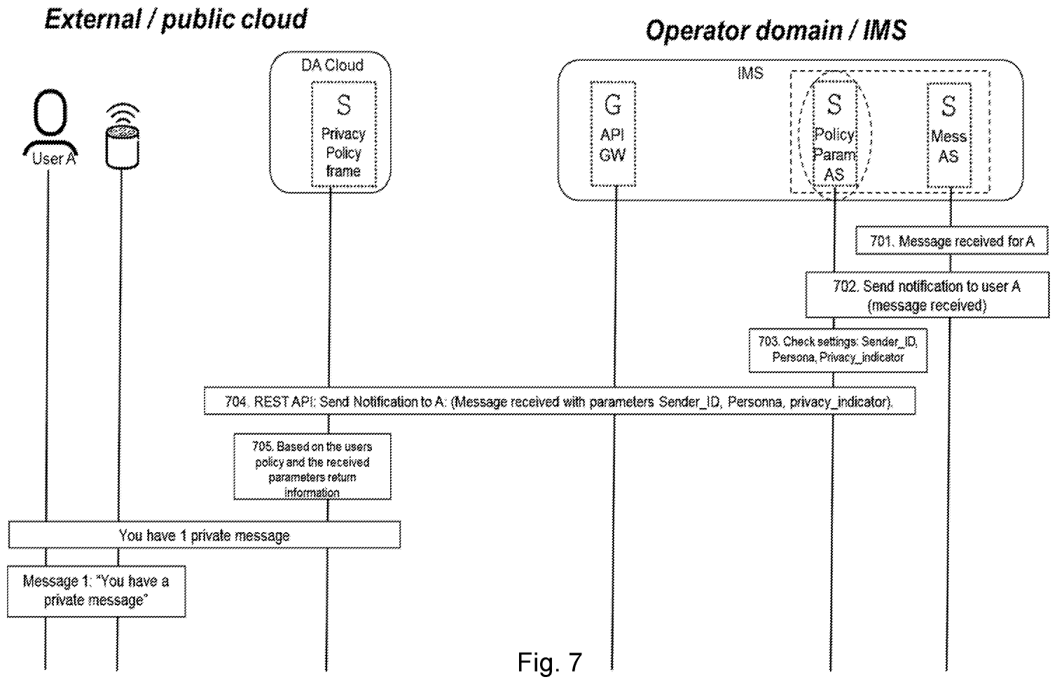

FIG. 7 is a combined signalling scheme and flowchart according to embodiments herein for handling messages of the user A.

Action 701. The second network node 150, such as a messaging AS of the IMS, may receive one or more messages for the user A from one or more originating parties or sending parties.

Action 702. The second network node 150 may determine or trigger to send notification of the received message to the user A.

Action 703. The second network node 150 may then check privacy of messages and setup privacy policy subscribed by the user A. E.g. check settings such as sender ID, persona, privacy indication or indicator, and/or similar.

Action 704. The second network node 150 may then transmit one or more notifications of messages e.g. an indication of a message to the first network node 151. Each notification of message is transmitted with a privacy indication. This may also be triggered by a request from the user. The second network node 150 may thus transmit notification of the messages received for the user A to the first network node 151. Each message is transmitted with a privacy indication. Respective sender ID and/or persona may also be transmitted.

Action 705. The first network node 151 may then handle the messages based on the respective privacy indication of each notification of message and may further take configured privacy policy into account. E.g. based on the users policy and the received parameters such as privacy indication, return information.

E.g. output to the user through the first output device 152 that the user A have 2 public message and 1 private message.

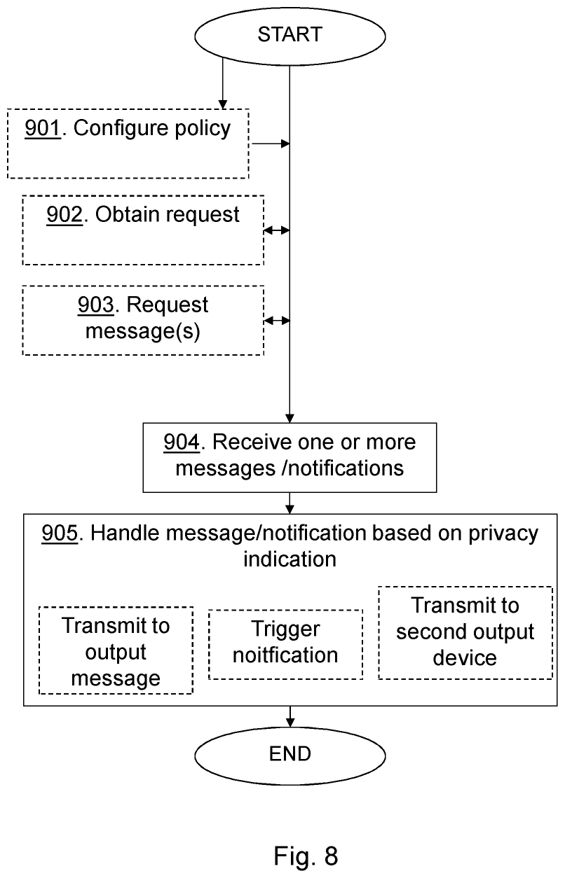

The method actions performed by the first network node 151 for handling messages of the user according to some embodiments will now be described with reference to a flowchart depicted in FIG. 8. The actions do not have to be taken in the order stated below, but may be taken in any suitable order. Actions performed in some embodiments are marked with dashed boxes. The first network node 151 may be a digital assistant.

Action 901. The first network node 151 may configure a policy indicating how to handle a privacy indication.

Action 902. The first network node 151 may further obtain, from the first output device 152, the request to retrieve one or more messages associated to the user. E.g. receive from the first output device 152.

Action 903. The first network node 151 may transmit, to the second network node 1501, a request to retrieve one or more messages associated to the user.

Action 904. The first network node 151 receives, from the second network node 150, one or more messages or notifications of messages associated to the user, and a respective privacy indication for each message. The privacy indication may be a flag bit, a name or number according to a pre-configuration.

Action 905. The first network node 151 further handles, based on the respective privacy indication, each message or notification of message. The first network node 151 may e.g. transmit the message to the first output device for outputting the message in case the privacy indication indicates a privacy level below a threshold. Alternatively or additionally, the first network node 151 may further trigger a notification to the user indicating that the message is of a privacy level equal or above a threshold in case the privacy indication indicates a privacy level equal or above the threshold. The notification may be transmitted to the second output device 153 of the user.

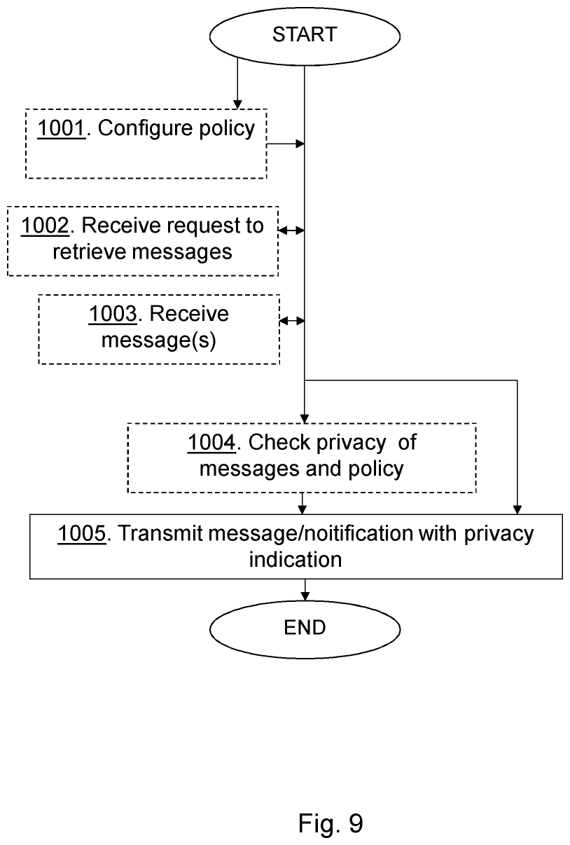

The method actions performed by the second network node 150 for handling messages of the user according to some embodiments will now be described with reference to a flowchart depicted in FIG. 9. The actions do not have to be taken in the order stated below, but may be taken in any suitable order. Actions performed in some embodiments are marked with dashed boxes. The second network node 150 may be an IMS node. The second network node 150 may be an Application Server (AS) node providing messaging service towards the first network node 151.

Action 1001. The second network node 150 may configure a policy indicating how to handle a privacy indication for the user. This may be configured or manually configured by the operator or the user. The configuration may be mirrored at the first network node 151, i.e. sent to the first network node 151.

Action 1002. The second network node 150 may receive, from the first network node 151, the request to retrieve the one or more messages associated to the user.

Action 1003. The second network node 150 may receive one or more messages associated to the user.

Action 1004. The second network node 150 may then check privacy of messages and check setup privacy policy subscribed by the user.

Action 1005. The second network node 150 transmits, to the first network node 151, one or more messages or notifications of messages associated with the user and a respective privacy indication for each message or notification of message. The second network node 150 may in response to said received request, see action 1002, transmit the one or more messages with the respective privacy indication. The second network node 150 may in response to said received one or more messages associated to the user transmit the one or more messages or notifications of messages with the respective privacy indication to the first network node 151. The privacy indication may be a flag bit, a name and/or number according to a pre-configuration.

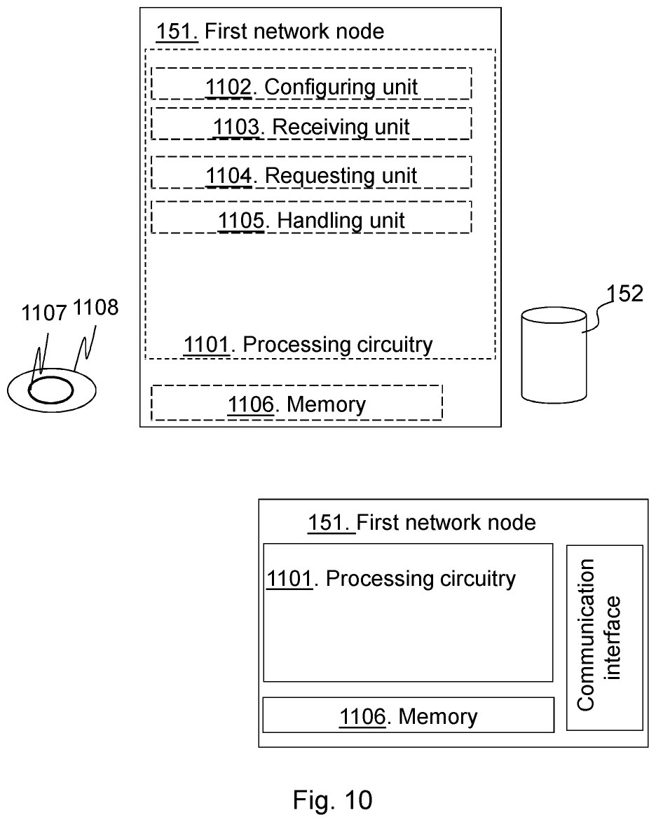

FIG. 10 is a block diagram depicting the first network node 151 for handling one or more messages of the user in the wireless communication network 100.

The first network node 151 may comprise processing circuitry 1101 e.g. one or more processors, configured to perform the methods herein. The first network node 151 may be a digital assistant.

The first network node 151 may further comprise a configuring unit 1102. The first network node 151, the processing circuitry 1101, and/or the configuring unit 1102 may be configured to configure the policy indicating how to handle a privacy indication.

The first network node 151 may further comprise a receiving unit 1103, e.g. a receiver or transceiver. The first network node 151, the processing circuitry 1101, and/or the receiving unit 1103 is configured to receive, from the second network node 150, one or more messages or notifications of messages associated to the user, and the respective privacy indication for each message. The first network node 151, the processing circuitry 1101, and/or the receiving unit 1103 may be configured to obtain, from the first output device 152, the request to retrieve one or more messages associated to the user. The privacy indication may be a flag bit, a name and/or number according to a pre-configuration.

The first network node 151 may further comprise a requesting unit 1104. The first network node 151, the processing circuitry 1101, and/or the requesting unit 1104 may be configured to transmit, to the second network node 150, the request to retrieve one or more messages associated to the user.

The first network node 151 may further comprise a handling unit 1105. The first network node 151, the processing circuitry 1101, and/or the handling unit 1105 is configured to handle, based on the respective privacy indication, each message or notification of message. The first network node 151, the processing circuitry 1101, and/or the handling unit 1105 may be configured to handle each message by transmitting the message to the first output device for outputting the message in case the privacy indication indicates a privacy level below a threshold. The first network node 151, the processing circuitry 1101, and/or the handling unit 1105 may be configured to handle each message or notification of message by triggering the notification to the user indicating that the message is of a privacy level equal or above a threshold in case the privacy indication indicates a privacy level equal or above the threshold. The first network node 151, the processing circuitry 1101, and/or the handling unit 1105 may be configured to transmit the notification to the second output device of the user.

The first network node 151 further comprises a memory 1106. The memory 1106 comprises one or more units to be used to store data on, such as privacy indications, policies, UE ID, messages, output device IDs, and applications to perform the methods disclosed herein when being executed, and similar. Furthermore, the first network node 151 may comprise a communication interface such as comprising a transmitter, a receiver and/or a transceiver, with one or more antennas.

The methods according to the embodiments described herein for the first network node 151 are respectively implemented by means of e.g. a computer program product 1107 or a computer program, comprising instructions, i.e., software code portions, which, when executed on at least one processor, cause the at least one processor to carry out the actions described herein, as performed by the first network node 151. The computer program product 1107 may be stored on a computer-readable storage medium 1108, e.g. a disc, a universal serial bus (USB) stick or similar. The computer-readable storage medium 1108, having stored thereon the computer program product, may comprise the instructions which, when executed on at least one processor, cause the at least one processor to carry out the actions described herein, as performed by the first network node 151. In some embodiments, the computer-readable storage medium may be a transitory or a non-transitory computer-readable storage medium. Thus, embodiments herein may disclose a first network node for handling messages of a user in a wireless communications network, wherein the first network node comprises processing circuitry and a memory, said memory comprising instructions executable by said processing circuitry whereby said first network node is operative to perform any of the methods herein.

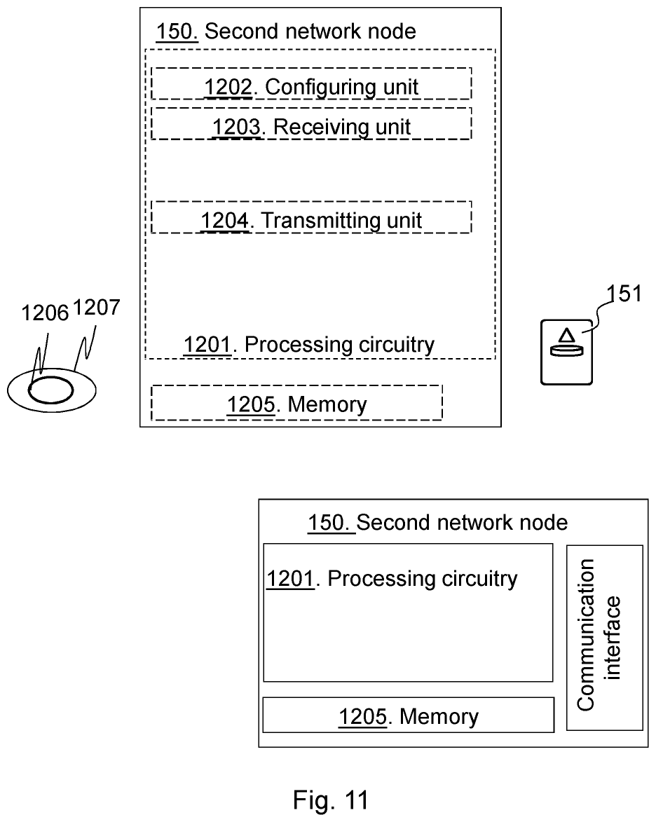

FIG. 11 is a block diagram depicting the second network node 150 for handling one or more messages of the user in the wireless communication network 100.

The second network node 150 may comprise processing circuitry 1201 e.g. one or more processors, configured to perform the methods herein. The second network node 150 may be an AS node providing messaging service towards the first network node 151.

The second network node 150 may further comprise a configuring unit 1202. The second network node 150, the processing circuitry 1201, and/or the configuring unit 1202 may be configured to configure the policy indicating how to handle a privacy indication for the user.

The second network node 150 may further comprise a receiving unit 1203, e.g. a receiver or transceiver. The second network node 150, the processing circuitry 1201, and/or the receiving unit 1203 may be configured to receive, from the first network node 151, the request to retrieve the one or more messages associated to the user. The second network node 150, the processing circuitry 1201, and/or the receiving unit 1203 may be configured to receive one or more messages associated to the user. The privacy indication may be a flag bit, a name and/or number according to a pre-configuration.

The second network node 150 may further comprise a transmitting unit 1204, e.g. a transmitter or transceiver. The second network node 150, the processing circuitry 1201, and/or the transmitting unit 1204 is configured to transmit, to the first network node 151, one or more messages or notifications of messages associated with the user, and the respective privacy indication for each message or notification of message. The second network node 150, the processing circuitry 1201, and/or the transmitting unit 1204 may be configured to transmit, in response to said received request, transmit the one or more messages with the respective privacy indication. The second network node 150, the processing circuitry 1201, and/or the transmitting unit 1204 may be configured to transmit, in response to said received one or more messages transmit the one or more messages or notifications of messages with the respective privacy indication to the first network node 151.

The second network node 150 further comprises a memory 1205. The memory 1205 comprises one or more units to be used to store data on, such as privacy indications, policies, UE ID, messages, and applications to perform the methods disclosed herein when being executed, and similar. Furthermore, the second network node 150 may comprise a communication interface such as comprising a transmitter, a receiver and/or a transceiver, with one or more antennas.

The methods according to the embodiments described herein for the second network node 150 are respectively implemented by means of e.g. a computer program product 1206 or a computer program, comprising instructions, i.e., software code portions, which, when executed on at least one processor, cause the at least one processor to carry out the actions described herein, as performed by the second network node 150. The computer program product 1206 may be stored on a computer-readable storage medium 1207, e.g. a disc, a universal serial bus (USB) stick or similar. The computer-readable storage medium 1207, having stored thereon the computer program product, may comprise the instructions which, when executed on at least one processor, cause the at least one processor to carry out the actions described herein, as performed by the second network node 150. In some embodiments, the computer-readable storage medium may be a transitory or a non-transitory computer-readable storage medium. Thus, embodiments herein may disclose the second network node for handling messages of the user in a wireless communications network, wherein the second network node comprises processing circuitry and a memory, said memory comprising instructions executable by said processing circuitry whereby said second network node is operative to perform any of the methods herein.

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a first network node in a wireless communications network for handling one or more messages of a user, the method comprising:
receiving, from a second network node, one or more messages or notifications of messages associated to the user, and a respective privacy indication for each message; and
handling, based on the respective privacy indication, each message or notification of message.

2. The method according to claim 1, further comprising:
obtaining, from a first output device, a request to retrieve one or more messages associated to the user.

3. The method according to claim 2, wherein the handling each message comprises transmitting the message to the first output device for outputting the message in case the privacy indication indicates a privacy level below a threshold.

4. The method according to claim 1, wherein the handling each message comprises triggering a notification to the user indicating that the message is of a privacy level equal or above a threshold in case the privacy indication indicates a privacy level equal or above the threshold.

5-6. (canceled)

7. The method according to claim 1, wherein the privacy indication is a flag bit.

8. The method according to claim 1, wherein the privacy indication is a name, number, or both name and number, according to a pre-configuration.

9-10. (canceled)

11. A method performed by a second network node in a wireless communications network for handling one or more messages of a user, the method comprising:
transmitting, to a first network node, one or more messages or notifications of messages associated with the user and a respective privacy indication for each message or notification of message.

12. The method according to claim 11, further comprising:
receiving, from the first network node, a request to retrieve the one or more messages associated to the user, and in response to said receiving the request, transmit the one or more messages with the respective privacy indication.

13. The method according to claim 11, further comprising:
receiving one or more messages associated to the user, and in response to said receiving the one or more messages, transmit the one or more messages or notifications of messages with the respective privacy indication to the first network node.

14-15. (canceled)

16. The method according to claim 11, wherein the privacy indication is a name, number, or both name and number, according to a pre-configuration.

17-18. (canceled)

19. A first network node in a wireless communications network for handling one or more messages of a user, the first network node comprising:
processing circuitry; and
a memory comprising instructions which, when executed by the processing circuitry, cause the first network node to:
receive, from a second network node, one or more messages or notifications of messages associated to the user, and a respective privacy indication for each message; and
handle, based on the respective privacy indication, each message or notification of message.

20. The first network node according to claim 19, wherein the first network node is further to:
obtain, from a first output device, a request to retrieve one or more messages associated to the user.

21. The first network node according to claim 20, wherein the first network node is to handle each message by transmitting the message to the first output device for outputting the message in case the privacy indication indicates a privacy level below a threshold.

22. The first network node according to claim 19, wherein the first network node is to handle each message or notification of message by triggering a notification to the user indicating that the message is of a privacy level equal or above a threshold in case the privacy indication indicates a privacy level equal or above the threshold.

23. (canceled)

24. The first network node according to claim 19, wherein the first network node is a digital assistant.

25. The first network node according to claim 19, wherein the privacy indication is a flag bit.

26. The first network node according to claim 19, wherein the privacy indication is a name, number, or both name and number, according to a pre-configuration.

27-28. (canceled)

29. A second network node in a wireless communications network for handling one or more messages of a user, the second network node comprising:
processing circuitry; and
a memory comprising instructions which, when executed by the processing circuitry, cause the second network node to:
transmit, to a first network node, one or more messages or notifications of messages associated with the user, and a respective privacy indication for each message or notification of message.

30. The second network node according to claim 29, wherein the second network node is to receive, from the first network node, a request to retrieve the one or more messages associated to the user, and in response to said receiving the request, transmit the one or more messages with the respective privacy indication.

31. The second network node according to claim 30, wherein the second network node is to receive one or more messages associated to the user, and in response to said receiving the one or more messages, transmit the one or more messages or notifications of messages with the respective privacy indication to the first network node.

32-34. (canceled)
